(19) United States
(12) Patent Application Publication
(10) Pub. No.: US 2012/0101747 A1
(43) Pub. Date: Apr. 26, 2012

(54) DETECTION AND IMAGING OF TURBULENCE IN A FLUID

(75) Inventors: John Kielkopf, Louisville, KY (US); Jeff Hay, Louisville, KY (US); Adam Willitsford, Louisville, KY (US)

(73) Assignee: UNIVERSITY OF LOUISVILLE RESEARCH FOUNDATION, INC., Louisville, KY (US)

(21) Appl. No.: 12/911,278

(22) Filed: Oct. 25, 2010

(51) Int. Cl. G06F 19/00; G01M 3/00

(52) U.S. Cl. 702/51; 702/50

(57) ABSTRACT

A system and method detect turbulence in a fluid by processing image data to isolate and detect fluctuations in a frequency range indicative of turbulence. By making use of a Fourier or other frequency transformation to convert a set of time-dependent intensity data into frequency-dependent intensity data, a range of frequencies can be selected wherein fluctuations in intensity are characteristic of turbulence, even under difficult conditions where turbulence is cannot be naively detected. A detector is capable of relying on ambient light conditions to provide sufficient transmission and fluctuation to detect the characteristics of turbulence. Detection of turbulence aids in aircraft navigation and meteorology, analysis of industrial and commercial exhaust, and detection of unexpected fluid events such as containment leaks.

### GOVERNMENT RIGHTS

The invention was made with Government support under National Institutes of Health contract No. OGMB080984. The Government has certain rights in the invention.

### FIELD OF THE INVENTION

The invention is generally related to imaging technology, and more particularly to the detection of turbulence in a fluid.

### BACKGROUND OF THE INVENTION

Turbulence is a stochastic flow characterized by chaotic, nonuniform movement within a fluid. A region of turbulence within a fluid results in rapid, unpredictable variations in pressure and velocity. In contrast to the smooth, organized, directional movement of laminar flow, much of the kinetic energy in a turbulent fluid is found in small, localized eddies that do not fit into any larger, regular structured flow. Turbulence often results from an incongruity between two regions of fluid flow. Solid objects moving through a fluid, or the interaction of fluid flows with different directions or conditions (such as temperature or pressure) may result in a region of turbulence.

Commercial aircraft encounters with atmospheric turbulence are the leading cause of passenger injuries, some of which result in fatalities. Clear Air Turbulence (CAT) can be encountered without warning, causing planes to accelerate suddenly in any direction, and creating alternately zero-g and high-g environments in aircraft where passengers and luggage alike can be flung about the cabin. Aviation industry reports put the annual cost in excess of one hundred million dollars.

The danger and potential expense creates an obvious need to enable avoidance procedures by means of advance warning of turbulent atmospheric conditions in the flight path. While active and passive techniques have been used for many decades for remote sensing of the atmosphere from the ground to detect and quantify turbulence, there is as yet no reliable technology affording advance warning for CAT onboard aircraft in flight.

Clear Air Turbulence (CAT) is turbulence that cannot be seen in ambient illumination by the eye and may be undetected by other sensors because of the absence of perceptible tracers in the moving air mass. When suitable tracers are present, active techniques with radio (radar) and light (LIDAR) detection and ranging are useful. Analysis of the Doppler shift of the backscattered radiation from either radar or LIDAR gives the large scale air speed, differential motions, and location in front of an aircraft. In the case of LIDAR, the signal is backscattered from aerosols entrained in the targeted turbulent flow, and requires a sufficient density to be detected above the noise and background. In radar the backscattered return arises from ‘intrinsic scatterers’ including aerosols as well as fluctuations in the refractive index for radio waves caused by temperature and water vapor gradients. In either case, as with all detection methods, there are times when the environmental conditions are favorable to detection and those when detection is improbable. While active techniques that probe the air and look for backscatter offer temporally and spatially resolved measurements, they can miss CAT even in cloud-free daytime air, and LIDAR as an optical supplement to radar is expensive and difficult to interpret.

Some previous attempts to passively detect turbulence have relied on the principle that turbulent air may have an absorption spectrum that differs significantly from still air. One conventional approach, for example, relies on a comparison of a wide emission spectrum between a reference spectrum and a detected sample of air. However, in practice the detection of a wide spectrum is difficult. The bands where the absorption spectrum differs can be difficult to detect at a level greater than the noise present in those bands, and the data is often not reliable.

A need therefore exists for a method of detection of turbulence that relies only on the properties of the turbulence itself and not on condition-variable properties of the fluid. Furthermore, a need exists for an optical detection method for turbulence that can operate passively without any emission from the detector. The method should inherently eliminate noise and therefore provide more highly significant and reliable detection data than the prior art.

### SUMMARY OF THE INVENTION

The invention addresses these and other drawbacks associated with the prior art by providing a system and method to detect turbulence in a fluid by measuring the intensity of radiation communicated through the fluid over time and processing that data to isolate and detect fluctuations that are indicative of turbulence. In some embodiments, a frequency transformation may be performed to convert a set of time-dependent intensity data into frequency-dependent intensity data, whereby fluctuations in intensity within a range of frequencies indicative of turbulence can be used to detect turbulence. In addition, in some embodiments, a passive image detector incorporating a multi-element sensor array may be used to measure the intensity of ambient radiation over time across a field of view.

Consistent with one aspect of the invention, a method for detecting turbulence in a fluid includes measuring an intensity of radiation in the fluid over time; performing a transformation of the measured intensity over time to generate an intensity of radiation over frequency; and detecting turbulence in the fluid based upon the transformed intensity of radiation over frequency.

Consistent with another aspect of the invention, a system for passively detecting turbulence in a fluid may include a passive image detector configured to measure a plurality of intensities of ambient radiation over time across a field of view using a multi-element sensor array; and a data processor configured to receive and process the plurality of intensities of ambient radiation over time from the detector and to detect turbulence using the processed data.

Consistent with another aspect of the invention, a method for detecting turbulence in a fluid includes measuring an intensity of radiation in the fluid over time, filtering the radiation according to frequency to produce an intensity that represents only radiation with intensity fluctuations in a pre-selected frequency range, and detecting turbulence in the fluid by evaluating the filtered intensity.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of an exemplary apparatus suitable for detecting turbulence according to one embodiment of the present invention.

FIG. 2 is a flowchart of a turbulence detection process consistent with the present invention.

FIG. 3 is a diagrammatic view of two detectors placed on board an aircraft to carry out an embodiment of the present invention.

FIG. 4 is a block diagram of a detection system including the detectors of FIG. 3.

FIG. 5A illustrates a leak monitoring and detection process according to one embodiment of the present invention.

FIG. 5B is a chart showing integrated intensity over frequency for an exemplary pixel of an image from the process of FIG. 5A.

FIG. 5C is a transformed image from the detection process of FIG. 5A consistent with the present invention.

FIG. 6A illustrates an exhaust monitoring and detection process according to one embodiment of the present invention.

FIG. 6B is a transformed image from the detection process of FIG. 6A consistent with the present invention.

FIG. 7A is an image taken of a super-cooled pipe.

FIG. 7B is a transformed image of the super-cooled pipe of FIG. 7A consistent with the present invention.

FIG. 8A is an image taken of a candle flame.

FIG. 8B is a transformed image of the candle flame of FIG. 8A consistent with the present invention.

FIG. 9 illustrates the configuration of an experiment associated with a turbulence detection example consistent with the present invention.

FIGS. 10A-10I are images produced by the experiment of FIG. 9 transformed according to one embodiment of the present invention.

FIG. 11 illustrates the configuration of an experiment associated with a turbulence detection example consistent with the present invention.

FIGS. 12A-12I are images produced by the experiment of FIG. 11 transformed according to one embodiment of the present invention.

FIGS. 13A-13I are images produced by an experiment and transformed according to one embodiment of the present invention.

FIG. 14A is an image taken of a hot plate.

FIG. 14B is a transformed image of the hot plate of FIG. 14A consistent with the present invention

### DETAILED DESCRIPTION

Turbulence produces variations in fluid density. In a moving fluid, these fluctuations are transported across the line of sight so that variations in intensity of transmitted light are correlated with the scale length of the packets and the flow speed. Imaging data treated in the temporal frequency domain quantify the turbulent fluctuations and reject the significantly stronger constant background. Fourier processing can filter the steady background so that only the fluctuations from turbulence are seen. The disclosed apparatus and method use these variations in light levels temporally at each point and spatially across a field of view as a method to detect fluid turbulence. In order to see these small variations in a large background, a system is described that offers a large dynamic range and low noise. Furthermore in order to map the turbulence in field of view, the detection scheme described herein spatially images temporal fluctuations.

As described herein, a detection method consistent with the invention relies on a fluid wherein some radiation is transmitted through the medium of the fluid. For example, in the atmosphere, visible light is substantially transmitted, as are many other frequencies of electromagnetic radiation. Fluid turbulence may disturb this transmission, which will result in fluctuations in the intensity of the radiation that is transmitted across the turbulent fluid. As one example, in atmospheric turbulence, significant fluctuations in transmitted visible and infrared light may be observed on the order of 2 to 10 Hz that are not present in still air.

Often these turbulent fluctuations will be invisible to the naked eye and even on a high-resolution video image. The range in intensity involved in these fluctuations may be only a small fraction of the total intensity of the light transmitted in the given range, and other intensity fluctuations may be present whether or not the fluid includes significant turbulence. However, where turbulence results in a characteristic intensity fluctuation within a set range of frequencies, it is possible to isolate and analyze fluctuations of only that frequency range. A method to do so is described below.

Ambient radiation is understood to mean any radiation which is not provided by the detection system itself; often sunlight for outdoor environments or conventional operational lighting for indoor environments may provide the ambient radiation. Because many fluid environments include sufficient ambient radiation to detect turbulence using the methods herein described, in one embodiment a detector in accordance with the present invention uses passive detection, which relies on the ambient radiation rather than providing supplemental radiation in conjunction with the imaging event. In other embodiments, however, active detection that relies on supplemental radiation may be used.

A detector in accordance with one embodiment of the present invention may be a high-speed camera capable of capturing sufficient frames per second to measure intensity fluctuations in the appropriate frequency range. In this embodiment, it is typically desirable for the sampling rate of the detector to be at least twice the maximum frequency within the frequency range of target intensity fluctuations. For example, to detect fluctuations on the order of 2 to 10 Hz, the detector may be configured to resolve at least 20 frames per second. The detector desirably has a dynamic range sufficient to detect the characteristic intensity fluctuations for a particular application while avoiding oversaturation in the conditions in which it will be used. For the detection of atmospheric turbulence in visible or near-infrared light, for example, a dynamic range of 60 db may be achievable by commercially available high-speed detectors and cameras. Oversampling (with a corresponding reduction in sampling rate), signal amplification, and other techniques known in the art may be used to increase the effective dynamic range.

In an exemplary embodiment, intensity data is captured and recorded over time. The data may be captured using any of a number of passive image detectors, e.g., using a single element photodiode, a camera that includes a regular spatial component, photomultiplier tubes, a bolometer, antennas, etc. Typically, these detectors use a single-element sensor or sensor array in the form of photoelectric elements, where electromagnetic radiation in a known range of frequencies is translated into an electric voltage. Thus, in one embodiment, the dynamic range of detection for the passive image detection is measured in electric voltage, with higher voltages corresponding to higher intensities of radiation. Other methods of measuring intensities of radiation are known; as long as fluctuations in intensity characteristic of turbulence may be accurately measured by the detector, the detector may be suitable for use with an embodiment of the present invention.

Once recorded, the data of intensity over time may be transformed into intensity over frequency. In one embodiment, a fast Fourier transform (FFT) is used to perform this processing. The Fourier transform assumes that the variations in intensity over the time interval can be expressed as the sum of sinusoidal functions each with a characteristic frequency and intensity. The result of the FFT is a discrete-time Fourier transform of the data, which shows an intensity for each frequency used in calculating the transform. One of ordinary skill in the art of signal processing will understand how to transform intensity data collected over time into components characteristic of the frequency domain. Because the transformation into the frequency domain isolates fluctuations in each frequency range from fluctuations that occur at other frequencies, it allows the fluctuations that occur in a frequency range characteristic of turbulence to be identified separately from other fluctuations not within that frequency range, even those that might be of stronger intensity.

It will be appreciated that a frequency range characteristic of turbulence may vary in different applications, and as such, the detection of turbulence may be limited in some embodiments to analysis of the transformed data within a particular frequency range. As noted above, for atmospheric turbulence, a frequency range of about 2 Hz to about 10 Hz may be characteristic of turbulence, and as such, it may be desirable to detect turbulence in such an application based upon the transformed data in this frequency range, or within a larger range that encompasses a 2-10 Hz spectrum. Typically, for most turbulence applications, the frequency range will in a relatively low frequency range, e.g., below about 1000 Hz, or below about 100 Hz.

In one embodiment, the transform may occur over a pre-defined time window. For example, where data is taken over 20 seconds, each one-second interval of data may be transformed separately. In this way, the frequency components of intensity in the light detected in each sample taken during a given one-second interval will be transformed together to create an intensity-over-frequency image of the field of detection for that one-second interval. In another embodiment, the time interval may be based on the sampling rate in order to ensure that each interval contains a sufficient number of sampling events. For example, each successive group of 200 frames of data may be taken to produce one intensity-over-frequency image.

Where the data collected has spatial extent, the spatial extent of the image may be preserved in the transformed data. This is important for some applications where the imaging data can be used to determine the direction or location of turbulence, as further described below.

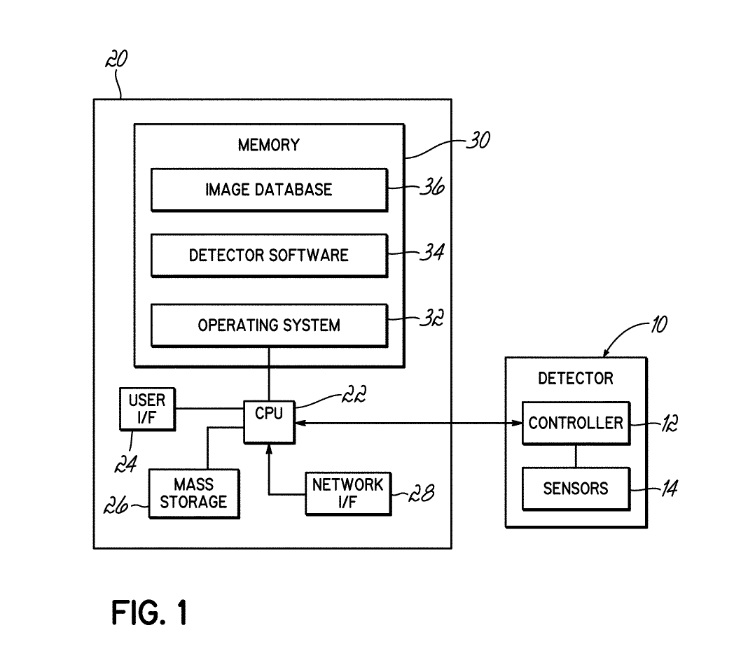

In one embodiment, such as where data is taken continuously over time, it is possible for the data to be analyzed and displayed while additional data is acquired. An example of such a system is shown in FIG. 1. In this system, a detector 10 includes a controller 12 and one or more sensors 14. Intensity images are collected by the sensors 14 and reported to the controller 12, which communicates with a computer 20. The computer 20 may be part of the detector 10 or may be a separate server, and in some instances no separate controller 12 or computer 20 may be required, i.e., all of the necessary logic may be integrated into a single electronic device. The computer 20 includes a CPU 22 and a memory 30, which may include the necessary components to store and interpret the images relayed by the detector 10.

For the purposes of the invention, computer 20 may represent practically any type of computer, computer system or other programmable electronic device. Moreover, computer 20 may be implemented using one or more networked computers, e.g., in a cluster or other distributed computing system. In the alternative, computer 20 may be implemented within a single computer or other programmable electronic device, e.g., a desktop computer, a laptop computer, a handheld computer, a cell phone, a set top box, etc.

Computer 20 typically includes a central processing unit 22 including at least one microprocessor coupled to a memory 30, which may represent the random access memory (RAM) devices comprising the main storage of computer 20, as well as any supplemental levels of memory, e.g., cache memories, non-volatile or backup memories (e.g., programmable or flash memories), read-only memories, etc. In addition, memory 30 may be considered to include memory storage physically located elsewhere in computer 20, e.g., any cache memory in a processor in CPU 22, as well as any storage capacity used as a virtual memory, e.g., as stored on a mass storage device 26 or on another computer coupled to computer 20. Computer 20 also typically receives a number of inputs and outputs for communicating information externally. For interface with a user or operator, computer 20 typically includes a user interface 24 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 20 may also include one or more mass storage devices 26, e.g., a floppy or other removable disk drive, a hard disk drive, a direct access storage device (DASD), an optical drive (e.g., a CD drive, a DVD drive, etc.), and/or a tape drive, among others. Furthermore, computer 20 may include an interface 28 with one or more networks (e.g., a LAN, a WAN, a wireless network, and/or the Internet, among others) to permit the communication of information with other computers and electronic devices. It should be appreciated that computer 20 typically includes suitable analog and/or digital interfaces between CPU 22 and each of components 24, 26, 28, 30 as is well known in the art. Other hardware environments are contemplated within the context of the invention.

Computer 20 operates under the control of an operating system 32 and executes or otherwise relies upon various computer software applications, components, programs, objects, modules, data structures, etc., as will be described in greater detail below. Moreover, various applications, components, programs, objects, modules, etc. may also execute on one or more processors in another computer coupled to computer 20 via a network, e.g., in a distributed or client-server computing environment, whereby the processing required to implement the functions of a computer program may be allocated to multiple computers over a network.

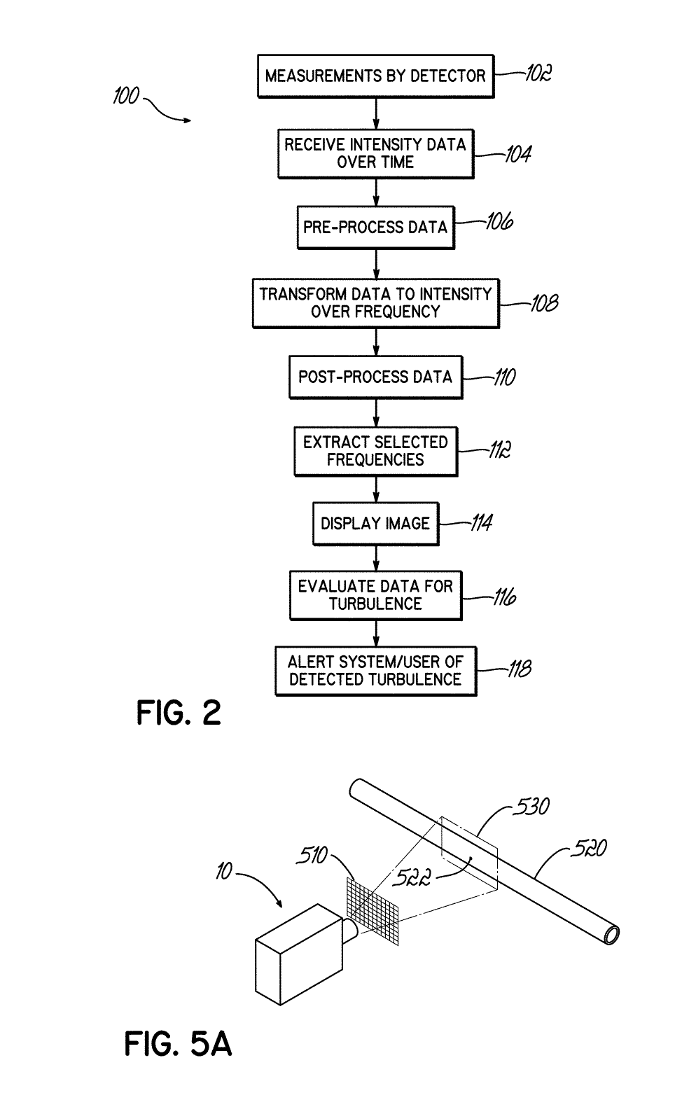

As an example, computer 20 may include image transform and detection software 34 used to implement one or more of the steps described above in connection with process 100 shown in FIG. 2 and described below. For the purposes of implementing such steps, an image database 36, storing sensor images from the detector 10, may be implemented in computer 20. It will be appreciated, however, that some steps in process 100 may be performed manually and with or without the use of computer 20.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, tangible storage media such as volatile and non-volatile memory devices, floppy and other removable disks, hard disk drives, magnetic tape, optical disks (e.g., CD-ROMs, DVDs, etc.), among others.

In addition, various program code described herein may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

FIG. 2 depicts an imaging and detection process 100 in accordance with one embodiment of the present invention. In block 102, a frame of data, which may reflect a single intensity value or an array of intensities, is taken by a detector. Block 104 represents a plurality of frames of data, each with an associated time stamp, being received by an appropriate data processor such as the computer 20. It will be appreciated that the number of frames of data, the frequency at which the frames are captured, the precision of the data, the resolution of any data array, etc., may vary in different embodiments.

After the data processor receives the set of frames to be processed for detection in block 104, any desired pre-transformation processing is optionally performed at block 106. For example, frames may be co-added to produce a higher dynamic range. Other pre-transformation processing that may be performed in some embodiments includes, for example, flat field normalization or dark subtraction.

Next, at block 108, the processed set of frames is transformed into the frequency domain through the use of a signal processing algorithm such as FFT. Other frequency transformation algorithms, e.g., other discrete Fourier transforms, windowing, Laplace transform, Mellin transform, or z-transform, may be used in various embodiments of the invention.

At block 110, post-transformation processing may optionally be performed. This may include the use of a background FFT image to control for known frequency variations. Other post-transformation processing that may be performed in some embodiments includes, for example, allowing for a DC-divided image to compensate for non-uniform illumination over the field of view.

Following post-processing 110, a pre-selected frequency range is evaluated at block 112, such as the mean or median intensity for components in the 2 to 10 Hz range. At block 114, if the original image was a spatial array of intensities, the data processor may create an image that is either displayed or stored for later display. This may involve an image wherein intensities are assigned to spatial locations in accordance with the pre-selected frequency range. Additionally, an evaluation of the data may be performed at step 116, which may involve comparing intensity values in the pre-selected frequency range to known reference values. The evaluation may lead to additional steps, for example an alert given to a user at step 118 if the data is consistent with turbulence. Many of these steps may be omitted in specific applications.

In another embodiment, the detection method may also be carried out in hardware or with an analog device. For example, where the selected frequency range for fluctuations characteristic of turbulence is known, it would be possible to directly filter the time signal and only allow the desired frequencies through, thus detecting the turbulence without the need to digitize the signal or post-process it. It is understood that the inventive concepts can therefore apply to a hardware detection solution, and that digital conversion of the signal and software analysis of the resulting images, while used in many of the exemplary embodiments herein, is not necessary to practice the invention.

In an analog device where the disclosed methods are practiced without subsequent image processing, the device itself may be responsible for filtering the measured intensities to isolate intensities in a pre-selected frequency range. The frequency-filtered intensity may then be used to establish the presence and location of turbulence, without the use of image post-processing.

In some embodiments of the invention, it may also be desirable to use an obstructing element in front of the detector to selectively block part of the field of view. In the case of a spatial sensor array, this element may be a mesh grid. Such an obstructing element has been found to increase the modulation levels of light intensity, acting as a mask that blocks light from hitting certain pixels of the sensor array, creating a shadow on those pixels. When turbulence changes the angle of transmission of the light, some of the light that would have otherwise fallen on nearby pixels now reaches the masked pixels, thus improving the ability of the device to detect fluctuations in intensity characteristic of turbulence. In an alternate embodiment wherein a single-element sensor is used rather than a sensor array, the obstructing element may be an opaque screen that blocks one edge of the sensor to allow for similar shadowing effects to improve detection.

Other variations will be apparent to one of ordinary skill in the art having the benefit of the instant disclosure.

Applications

One of ordinary skill will appreciate that the detection method described herein has a wide variety of applications. A few examples are provided below, although the invention should not be understood to be limited to only the disclosed embodiments. The invention may be valuable in any situation where detection of turbulence in a fluid, whether a liquid or gas, is useful.

### Air Navigation

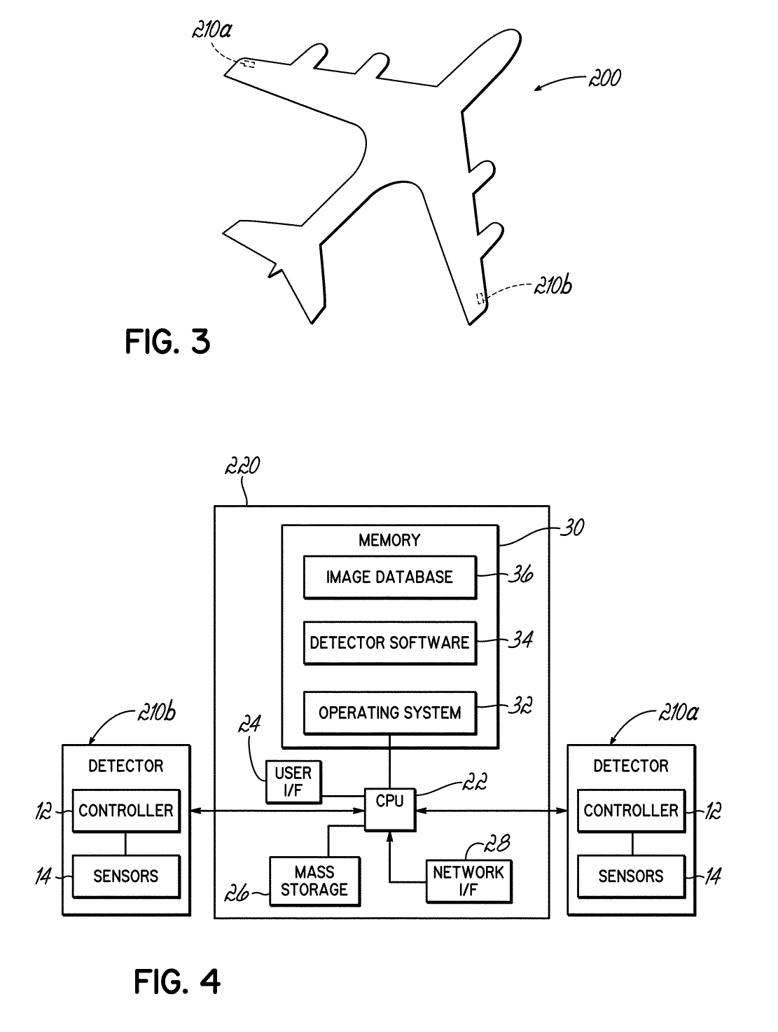

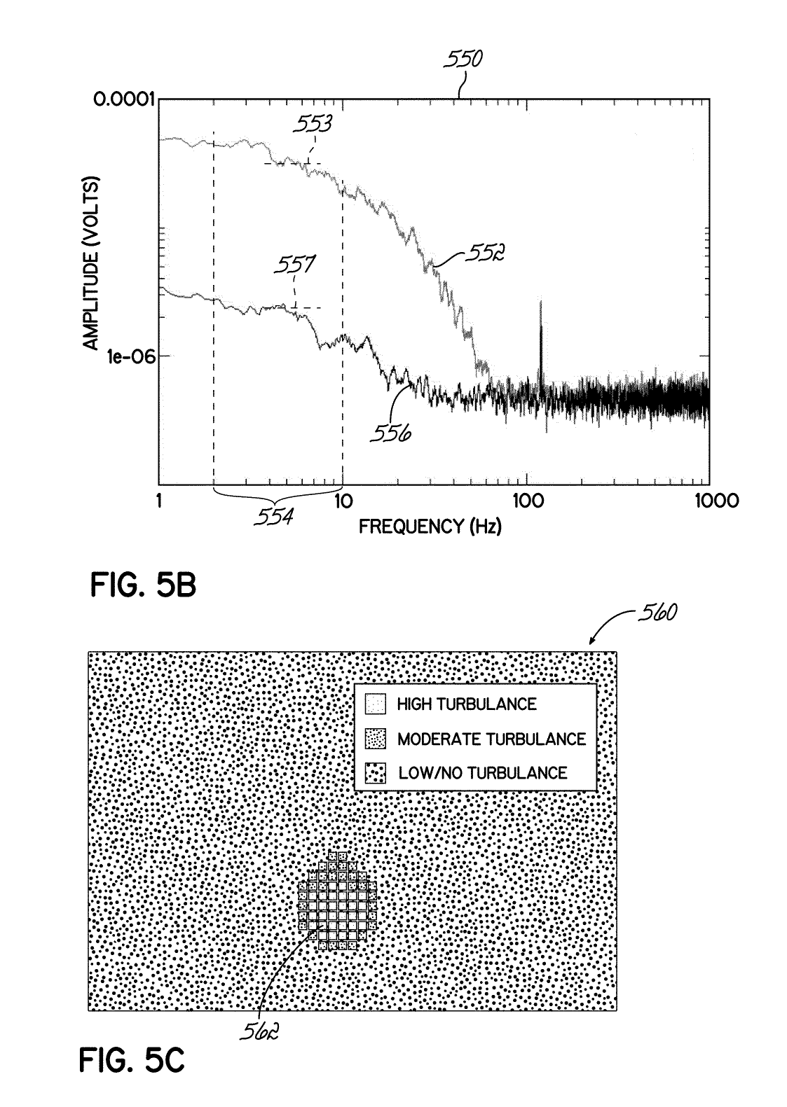

One application of the invention is in an airborne vehicle such as an aircraft. As shown in FIG. 3, a vehicle 200 such as a commercial airplane may include two detectors 210a and 210b to detect turbulence in the path of the plane. FIG. 4 illustrates that the detectors 210a,b may be connected to the same data processor 220, which is optimally used to process the data coming from both detectors 210a,b. The detectors 210a,b may return an array of intensity data that subtends a significant forward angle within each detector's field of view. The data processor 220 compares images coming from both detectors 210a,b within the same time window, identifying spatial locations on each image that show characteristics of turbulence as explained above. If turbulence is found in both fields of view, the data processor 220 compares their locations in each image to triangulate the projected distance of the turbulence from the plane's present location, using any number of known algorithms to do so. Ideally, the presence and distance of turbulence can be relayed to the plane's navigation system and used by the operators of the airplane (both pilots in the air and control systems elsewhere) in time to respond appropriately to the detected turbulence.

Although the embodiment described above and shown in FIGS. 3 and 4 uses two detectors to more accurately locate turbulence, a single detector may be used consistent with the invention to detect atmospheric turbulence in this exemplary application as in the other examples described herein using a single detector. Likewise, the use of multiple distinct detectors to resolve the distance and/or location of turbulence within a field of view, as described above, may be advantageous when used in conjunction with other exemplary applications described herein. The use of a single detector or multiple detectors should not be seen as limiting the number of detectors that may effectively locate turbulence in any specific application.

Alternatively, a device similar to the one above may be deployed in a ground station associated with air traffic control. The take-off and landing of aircraft on runways creates turbulence which can affect the performance of subsequent airplanes. If the appearance and dissipation of turbulence can be accurately tracked consistent with the present invention, air traffic control can more efficiently and safely direct planes.

### Weather and Atmospheric Mapping

An embodiment of this detection method may be used as part of conventional weather detection technology, which often includes radar and other ground and satellite imaging. In accordance with an embodiment of the present invention, conventional data which shows intensity over time, including intensity data from active detection methods such as radar and LIDAR, can be transformed and analyzed according to the present invention. By detecting and triangulating regions of turbulence over a large field of view, it may be possible to geographically locate weather phenomena associated with turbulent air.

### Leak Detection

In many industries, gas is stored and transported under pressure. Leakages in the vessels used to contain these gases can be costly and, if any of the gases are toxic or volatile, also dangerous. One embodiment of the present invention can detect the turbulence associated with a leakage. A detector monitors a container, such as a length of pipe or gas tank. Each set of frames is analyzed, and an alert is issued if the intensities characteristic of turbulence exceed the reference intensities in the appropriate frequency range, indicating turbulence. If occasional but short-lived environmental turbulence is expected, the detector can optionally be adjusted to only issue an alert if the detected turbulence persists for a duration that is longer than expected for environmental turbulence but consistent with sustained turbulence caused by gas leakage.

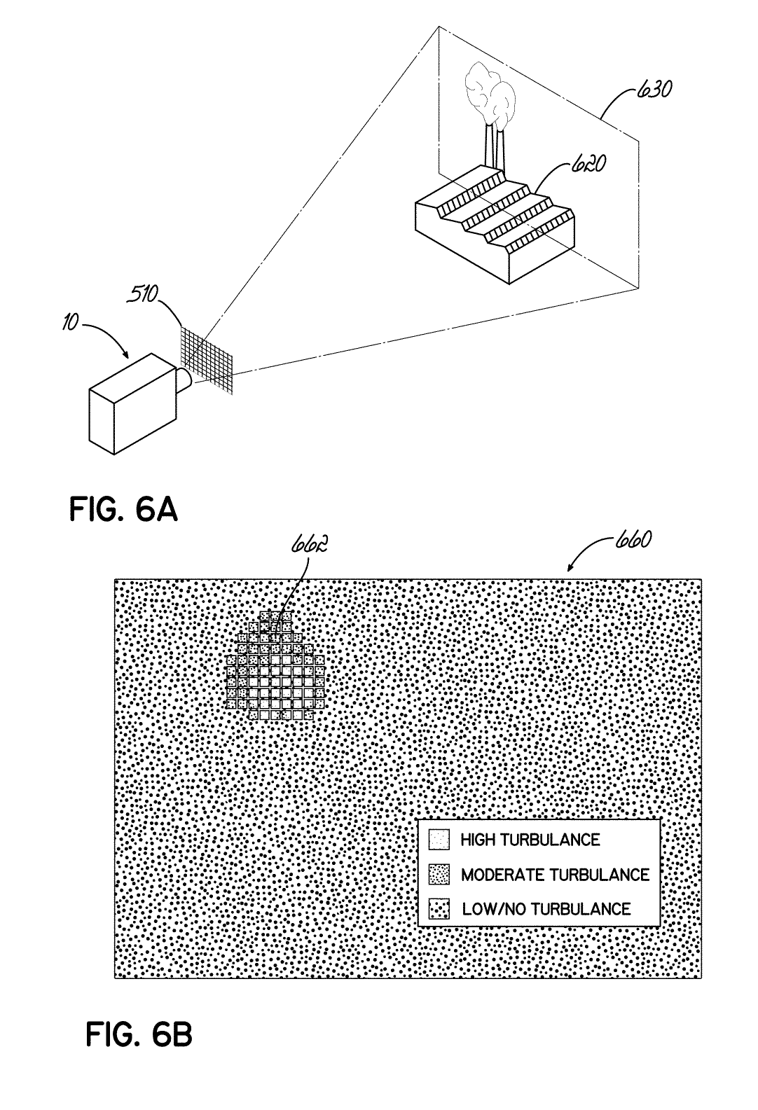

In FIG. 5A, the detector 10 is shown monitoring the pipe 520 in order to detect leaks such as the rupture 522 shown in the image. The detector's field of view is illustrated by broken line 530. Intensity images of light within the field of view are returned to a data processor, which may be embodied by the computer 20 described in conjunction with FIG. 1.

The imaging apparatus in FIG. 5A includes a mesh grid 510 located between the detector 10 and the possible turbulence. This increases the modulation levels of light intensity and may improve detection as explained above.

As multiple images are returned to the data processer over time, a set of these images is transformed to reflect intensities over the frequency domain, which may be compared to a known intensity-over-frequency image used as a control. Each pixel of the image now contains a data profile similar to the graph 550 presented as FIG. 5B. Of the full intensity data 552 for a given pixel, the value of pre-selected frequency sub-domain 554 is returned to represent that pixel. What is returned may be a difference between the measured intensity 553 computed from the intensity data 552 and a reference intensity 557 computed as an average over the same sub-domain 554 from reference data 556, both of which are shown on the graph 550.

Following transformation and processing, an image 560 such as that shown as FIG. 5C may be produced, wherein high-intensity portions of the display represent a region of detected turbulence 562. The presence of the mesh grid 510 can be seen as dark lines within the turbulent region 562. This image 560 may be returned to a user. Alternately, the image 560 may be used by the system in order to take some automated action such as sounding an alarm or altering the gas flow in a delivery system. One of ordinary skill will understand that the computer code associated with the processed data may be adapted to use a limited portion of the data for detection and automated response without evaluating the full image; for instance, a detection system may take action whenever a set number of pixels report above a set intensity for the pre-selected frequency without considering the positions of those pixels. Alternatively, the system may evaluate a function of the frequency-transformed intensities to return a single number or a small list of numbers which is then compared to an acceptable range to determine the presence or absence of a detection event. In each of these exemplary applications, the frequency-transformed data is used to respond to the perceived presence or absence of turbulence in the field of view of the detector 10.

The above example is not intended to limit the scope of usage for this monitoring process, and many other variations will be recognized by one skilled in the art. For example, any leakage that causes turbulence could be detected as described above. It is contemplated that the contained fluid may be gas or liquid, and that the environment may be gas, liquid, or even vacuum. Some containers exist to separate lower-pressure content from a higher-pressure environment, such as submerging vehicles and vacuum chambers, in which a leak results in the surrounding fluid entering the chamber. It is understood that a monitoring device as described above can detect the turbulence associated with such a “negative pressure leak” as well.

### Exhaust and Industrial Emissions

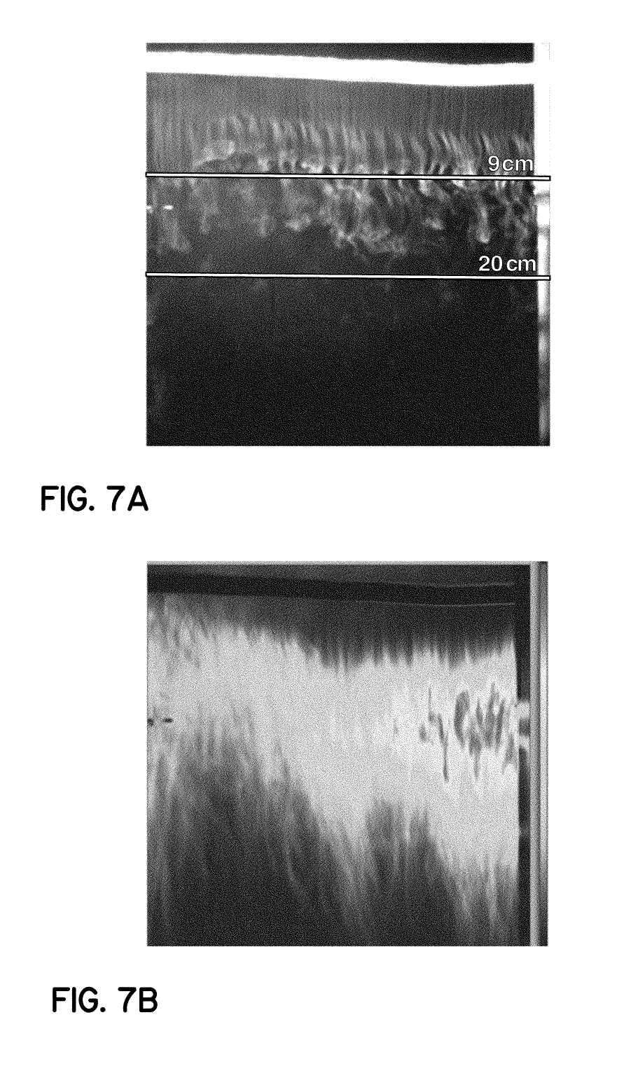

In addition to detecting the turbulence caused by the weather and by accidental emission, it is also possible to detect intentional emissions. Gas waste emissions released by industrial plants, the waste heat associated with environmentally controlled buildings, and even vehicle exhaust each result in turbulence where the expelled fluids interact with the atmosphere. As described above with respect to leakages, the turbulence arising from the expulsion of exhaust gas can be detected, recorded, and visually depicted as desired. FIGS. 6A and 6B illustrate a detector 10 and accompanying mesh grid 510 with a field of view 630 selected for the detection of turbulence due to the emissions from a building 620, and a resulting image 660 showing a region of turbulence 662 produced according to one embodiment of the present invention.

The flow rate of exhaust may be determined in reference to the frequency range and feature size of the detected turbulence. By determining the exhaust flow, it may be possible to measure the quantity and properties of the exhaust, as well as quantifying the amount of pollution that the exhaust represents. These and other features of exhaust and industrial emissions may be useful to measure and analyze, as understood by one of ordinary skill, using the methods described herein.

### Surface Temperature

When the atmospheric temperature differs from the surface temperature of a solid or a liquid, convection currents are formed as the air adjacent the surface is heated. The interaction of these convection currents with the atmosphere may cause turbulence, which can be detected using an embodiment of the present invention.

Exemplary Working Examples

The following are examples of passive detection of turbulence using high dynamic range imaging (18-20 bits) to follow subtle changes in transmitted ambient light intensity. As described above, in one application, ambient light fluctuations may be used to create a temporal frequency spectrum for turbulent and non-turbulent cases by Fast Fourier Transform (FFT) processing. It has been found that turbulent fields show stronger low frequency (2-10 Hz) components over non-turbulent conditions, thus enabling a simple and straight forward means of threshold detection of turbulence.

These examples were conducted using two different detectors—a single-element sensor, and a multi-element sensor array.

The first imaging detector used a single InGaAs photodiode with a high gain low noise amplifier yielding a dynamic range around 20 bits, while maintaining a relatively low cost. The signal was digitized using an NI-9234 24-bit ADC from National Instruments and processed using LabVIEW data acquisition software. The large dynamic range allowed the system to detect variations in intensity as small as one part in a million while remaining unsaturated from bright sunlit backgrounds.

The inherent noise of the single element photodiode system was measured to be on the order of 600 nV; however, the background noise under operating conditions (some of which was background turbulence) was much greater. The amplifier saturated at 6 V giving the photodiode system a possible dynamic range of 70 dB. However 1 V was found to be more typical of bright sunlit backgrounds. The detector operated at a dynamic range of approximately 60 dB under real world conditions. The camera was operated at near saturation levels.

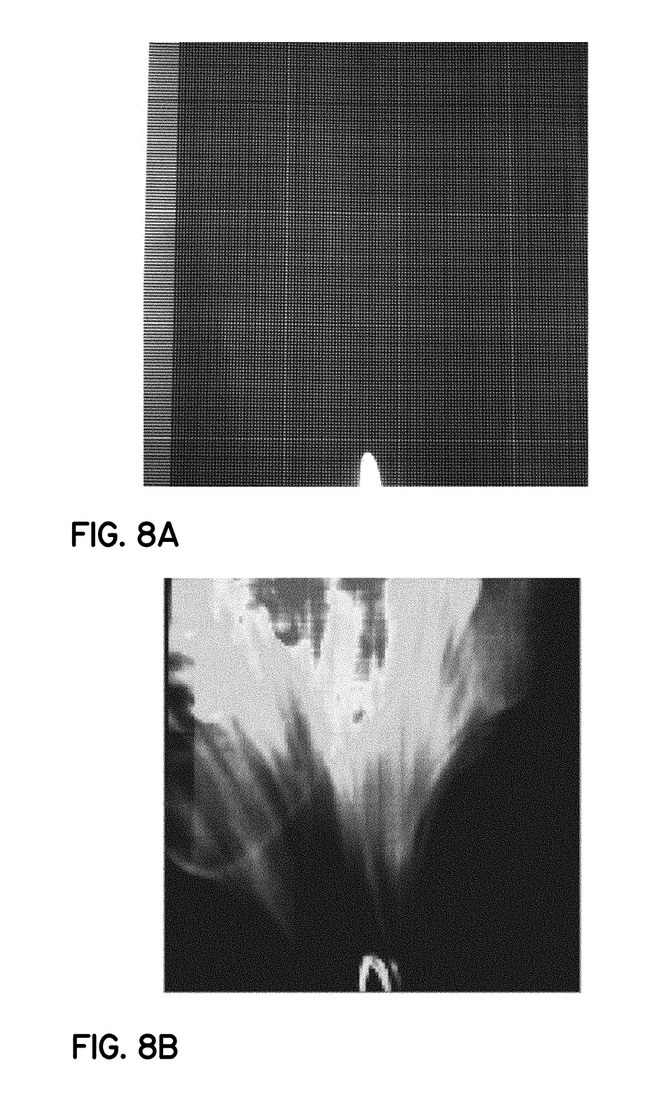

The second detector used a Photron Fastcam high speed camera (APX RS). The required large dynamic range was achieved by oversampling at rates as fast as 60,000 fps and then co-adding images to increase the effective bit depth of the camera. The high speed camera had the advantage of spatially resolving the turbulence by simultaneously acquiring data points across the field of view. Some of the resulting spatial images are illustrated in the Drawings, both pre-transformation images illustrating the detector's field of view (FIGS. 7A, 8A, and 14A) and post-transformation images illustrating the effects of turbulence in the selected frequency range (FIGS. 7B, 8B, 10A-10I, 12A-12I, 13A-13I, and 14B).

### WORKING EXAMPLE 1

### Water Vapor Turbulence from a Super-Cooled Pipe

A first working example was based upon the well-known laboratory phenomenon where turbulence is clearly discernible because of entrained water vapor. Downward airflow over a super-cooled pipe carrying liquid nitrogen was measured in order to identify specific features and regions in the turbulent flow and associate them with their respective frequency spectra. Atmospheric water vapor condensed on the pipe, and then sublimated as a dense aerosol tracer into the turbulent flow driven by gravity.

Light intensity was measured as a function of time for one sampled spatial element of this scene using a single photodiode sensor and a lens focused on a spot approximately 5 mm in diameter. The field of view of the sensor was moved in 1 cm steps from the bottom of the pipe in order to determine the temporal signal in regions with different spatial turbulent scale lengths. Data were collected for approximately 1 minute at each sampled element at 2048 samples/s to a maximum distance of 20 cm below the pipe. The first few centimeters were dominated by a laminar flow where no turbulence was discernible. Farther from the pipe the beginnings of the classical turbulence was seen where larger eddies formed first followed by smaller eddies until viscosity dispersed the energy and the turbulence was no longer visible. At approximately 9 cm below the pipe, turbulence appeared to be at a maximum, and at 20 cm below the pipe the turbulence was no longer visible. The low frequency rise in amplitude characteristic of turbulence is evident in the measurement at 9 cm and is much greater than at 20 cm below the pipe. A 9 db signal-to-noise ratio was measured for the region integrated from 2 to 10 Hz. The 20 cm measurement was used to represent the background signal, including system noise and possibly background turbulence characteristic of indoor air movements. The increase in intensity in the 2 to 10 Hz frequency range provided a method of detecting turbulent conditions.

Next the same scene of water vapor was imaged in a turbulent sheet using the Photron Fastcam high speed camera. Image data were collected at a rate of 500 frames per second with the resolution of the camera set to its full frame of 1024×1024 pixels. A total 6144 frames (limited by on-camera storage) were collected yielding approximately 12 seconds of image data. Four frames were then co-added (reducing the effective frame rate to 125 fps) in order to increase the dynamic range as well as reduce the size of the data set for faster processing.

The co-added frames were then used to produce a frequency spectrum for each pixel to produce a 1024×1024×1536 data space with two spatial axes and one temporal axis. Taking a pixel by pixel Fourier transform along the time axis resulted in a transformed data space in which the third axis was frequency rather than time. Separate sample planes in the transformed space were images of the scene in distinct frequency ranges. An integration of the 2-10 Hz components displayed in false color reveals the spatial distribution of the elements of the scene with signals in the 2-10 Hz region characteristic of turbulence. FIG. 7B shows a grayscale of this false color image next to a grayscale of one frame of the untransformed temporal image shown as FIG. 7A. To eliminate bias due to static non-uniformities (that is, variations in illumination or imager response) across the scene, a corresponding 0-2 Hz image was created, representing the constant “flat field” across the image. This reference image was used to normalize the intensities for the images of turbulence at higher frequencies. At 9 cm below the pipe the region was shown to be highly turbulent, and at 20 cm below the pipe the turbulence was nearly indistinguishable from the background. The signal-to-noise ratio for a pixel showing strong turbulence in the resulting image was 14 dB.

### WORKING EXAMPLE 2

### CAT Based on Temperature Gradient from a Candle

A second working example involved imaging conditions where there was fully expected to be strong turbulence created from the temperature gradient above a lit candle. This allowed expected CAT to be imaged for validation of the results with a reasonable assumption of where the turbulence will be located.

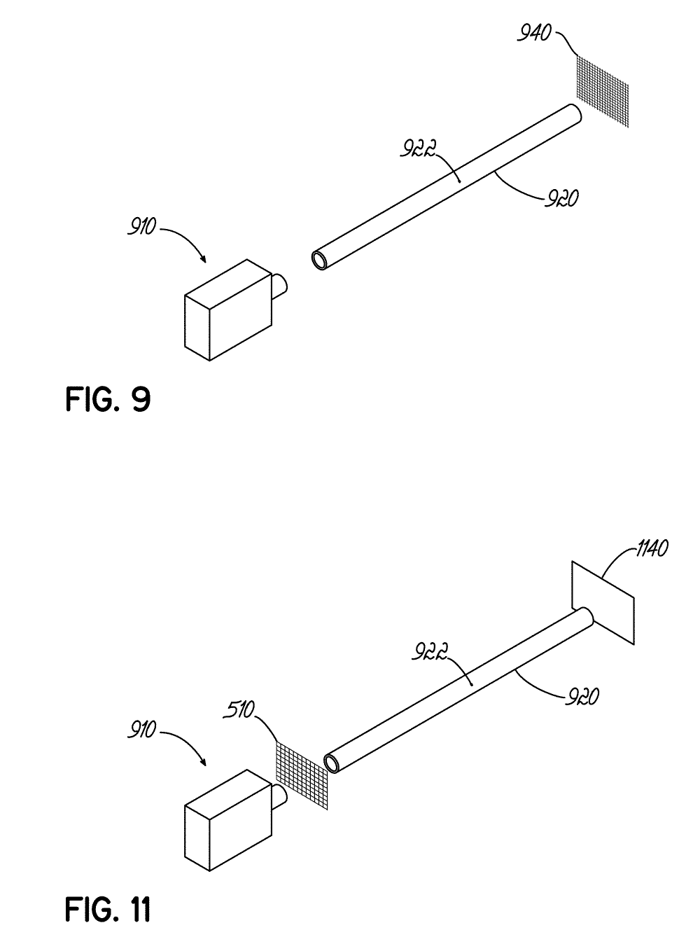

The observed optical path was disturbed with a candle that was placed in front of a small-scale grid target as shown in FIG. 8A. The black and white pattern was placed behind the turbulence to maximize the modulation of the signal resulting from when the refraction in the air shifts image elements on and off the black and white boundaries as seen at the detector. To image the grid pattern, the high speed Photron camera was again operated at 500 frames/s and post-processed to 125 frames/s as previously described. FIG. 8B shows a grayscale false color map of air above a burning candle with integrated 2-10 Hz components normalized against a constant flat background. The signal-to-noise ratio in this spectral image was measured to be 14 dB for a strong turbulent region. The image shown was reduced in size by spatially binning 8×8 areas to remove the grid pattern for purposes of clarity. Turbulence is clearly seen, formed from the thermal driven inhomogeneities in the index of refraction of turbulent air in the strong temperature gradient above the candle.

### WORKING EXAMPLE 3

### CAT Based on Invisible Compressed Gas Flow

A third working example created CAT inside a cardboard tube used to shield the optical path from external disturbances of the imaged air. A flow of gas from a compressed nitrogen tank was injected into the tube and the system was configured to detect the resulting turbulence. This case of CAT is much weaker in terms of modulated light than the others and imperceptible by eye.

To eliminate any outside effects on our measurements, namely room air currents, a cardboard tube, approximately 1.5 m in length, was placed in the optical path of a single-element sensor. This shielded any outside flow from entering the optical path. A small hole at the midpoint of the tube to allowed the injection of compressed dry nitrogen to create turbulence along the line of sight. An increased amplitude in the low frequency spectrum through the tube was detected when the compressed gas was injected as compared to the background measurement without the flow. The signal-to-noise ratio for the 2-10 Hz region was 8 dB in these images. These measurements were repeated without the tubing in place. The removal of the tube gave a measure of the room's inherent air turbulence. The frequency background spectra were comparable to the turbulence excited in a quiet tube. The turbulent flow inherent to the room was tracked to an air-handling register in the ceiling.

The successful detection of the CAT indicated that modulations in light levels were present upon the introduction of gas into the tube. The modulation level was lower than previous examples since individual frames did not show obvious variations on playback, in contrast to the case with the candle. To spatially resolve the turbulence in the scene and see the evolution of the turbulence through time, the high speed camera was optimized to ensure the highest sensitivity possible.

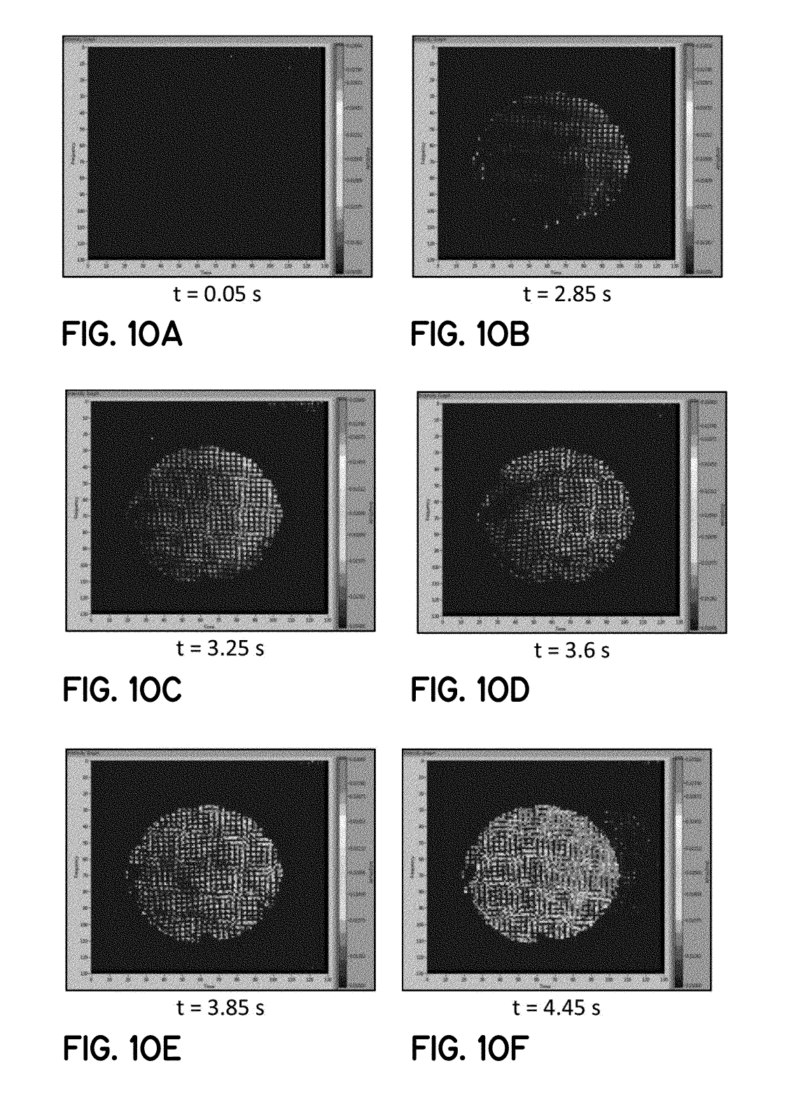

The high speed Photron Fastcam 910 was set up to image through the tube 920 to the grid pattern 940 at the other end, while gas was introduced at a hole 922 in the middle of the tube 920, as shown in FIG. 9. The camera recorded images at a rate of 60,000 fps. At this speed the camera was limited to a maximum region of 128×128 pixels. The camera recorded for a total of ˜6.5 s, limited by the camera's internal storage, yielding approximately 390,000 frames. Approximately halfway through acquisition (t≈3), compressed air was injected into the tube creating a clear air turbulent flow. To the eye there was no distinguishable change in the image, yielding true clear air turbulent flow. To image this flow, the 390,000 frames were post-processed in order to pull the clear air turbulence frequency spectra out of the noise.

The data processor co-added 300 frames which increased the dynamic range of the camera from 10 bits to a little over 18 bits allowing the multi-element sensor array to approach the sensitivity of the single element sensor. This co-addition also reduced the effective frame rate to 200 fps. As with the water vapor images, FFTs were performed on each series of pixels creating a single frequency spectral image representing the intensity of the 2-10 Hz region of the spectrum which was then normalized with the 0-2 Hz DC signal as previously described.

The image processor used a set of 200 frames per FFT, resulting in a spectral bin width of 1 Hz and a temporal size of 1 s for each frequency spectral image. The initial frame of the 200 frame length FFT was staggered by 10 frames, producing a step of 0.1 seconds between frequency images for a total of 111 frequency images over the entire acquisition time. The spatial evolution of the turbulence in the scene was visible in the 2-10 Hz frequency range when played back sequentially.

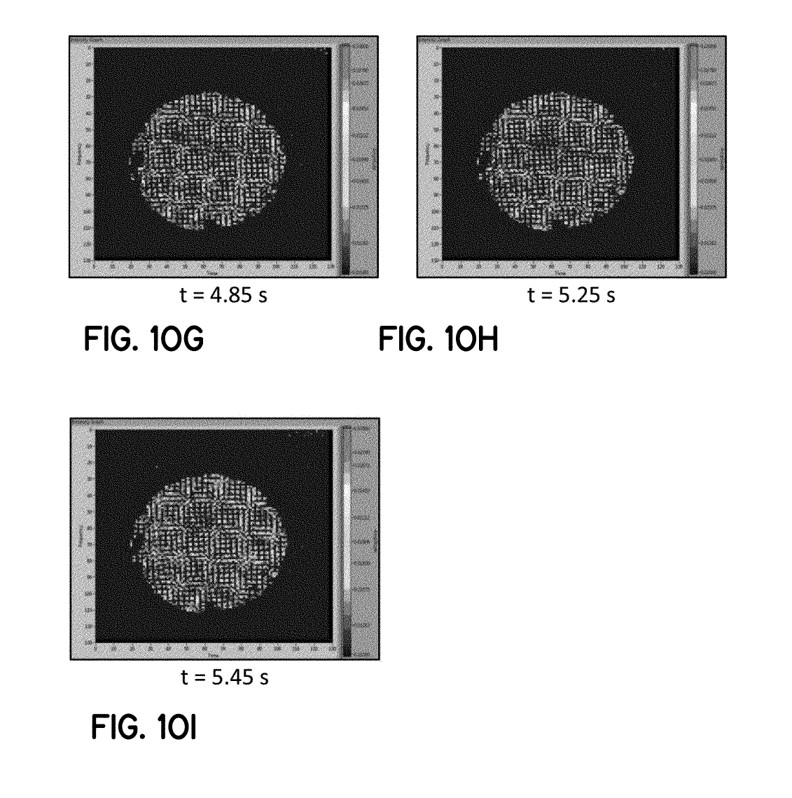

By injecting the turbulent flow halfway through a single acquisition, the experiment benefited by comparing the flow and no flow cases during the same image sequence. The evolution of the turbulence was seen with the disclosed imaging and post-processing technique using the normalized integrated intensities associated with the 2-10 Hz components of the frequency spectrum. A measured signal-to-noise ratio for strong turbulence was 11 dB. FIG. 10 shows 9 images representing the 2-10 Hz normalized integrated intensity centered around the time indicated. A sharp increase in intensity marked the initial formation of the turbulence at ˜3 s.

### WORKING EXAMPLE 4

### Detection of Turbulence with Grid Mesh Between Camera and Target

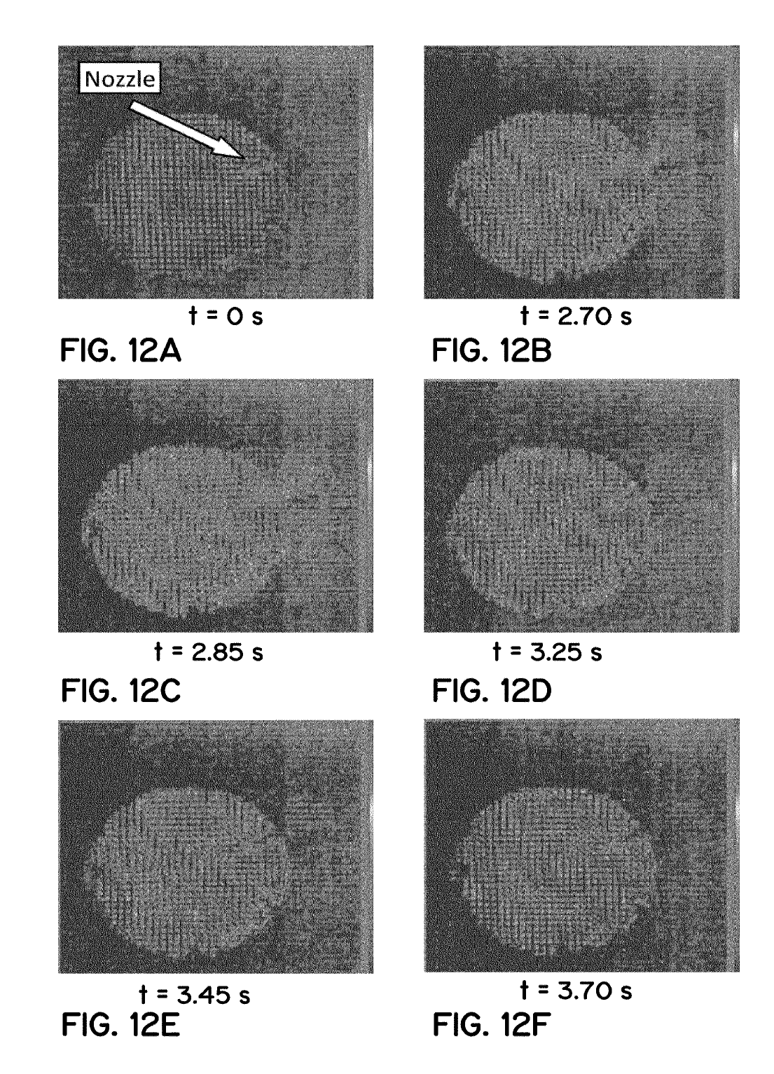

To test the effectiveness of a mesh grid to enhance detection, the same procedure as described for Working Example 3 was followed, with the addition of the grid mesh 510 placed between the turbulence and the camera 910, and the background 1140 changing to a uniform white surface, as shown in FIG. 11.

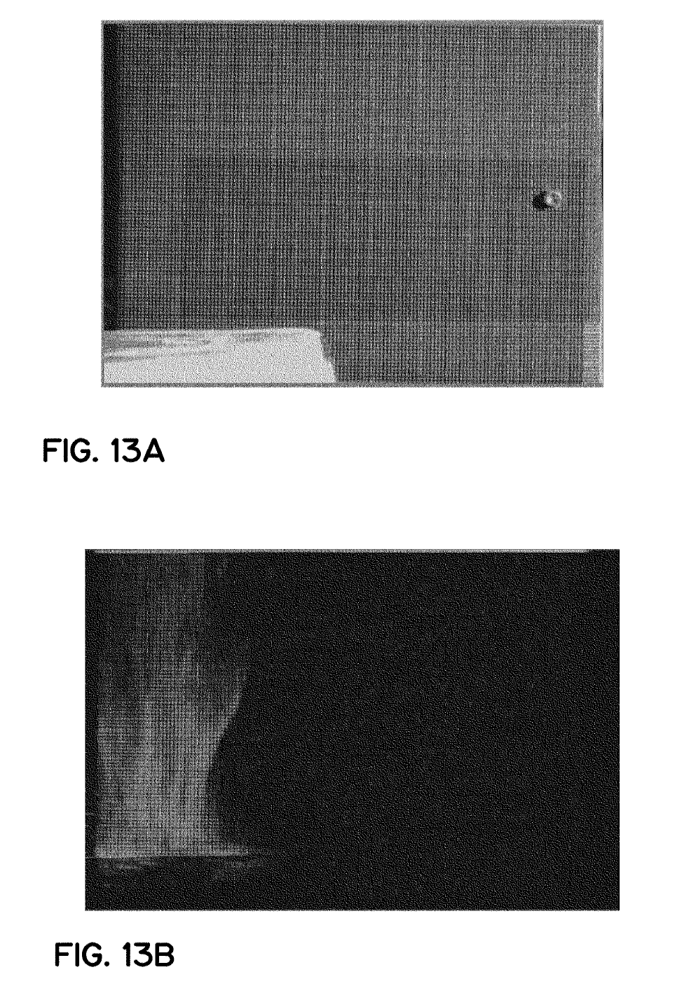

FIG. 12 shows a time series of 9 images representing the 2-10 Hz normalized integrated intensity centered around the time indicated. The images show an increase in intensity at the time t=2.30 s when flow was introduced into the tubing. The sequence shows the spatial distribution of the turbulence and its evolution through the scene both temporal and spatially. This demonstrates the ability to use a grid mesh between the target and camera to increase the modulation of the received light.

### WORKING EXAMPLE 5

### Detection of Gas Flow Based on Proximity of Tank Nozzle

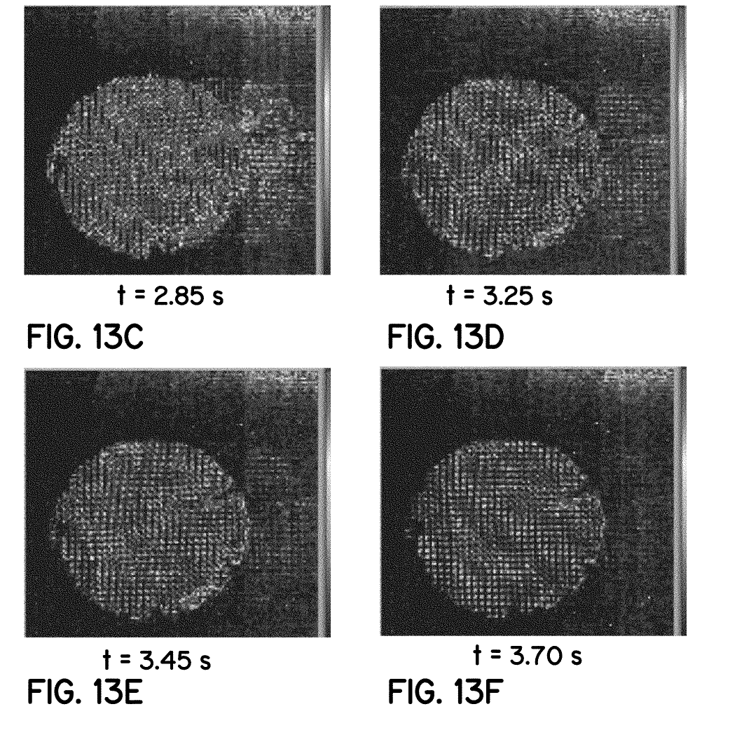

FIG. 13 shows the turbulence resulting from gas being expelled directly from the nozzle of a compressed nitrogen tank. The nozzle is seen in the upper right side of the images. At t=2.70 s the gas begins to flow. A dramatic increase in the intensity of the image is seen. The data were collected and processed in the same manner as before as above, with the exception that the gas was not being ejected into the tubing. Instead, the nozzle was placed directly in the field of view, more accurately simulating a gas leak. It can be seen from the figure the location and time at which gas begins to flow in the scene.

### WORKING EXAMPLE 6

### Measuring Thermal Variations

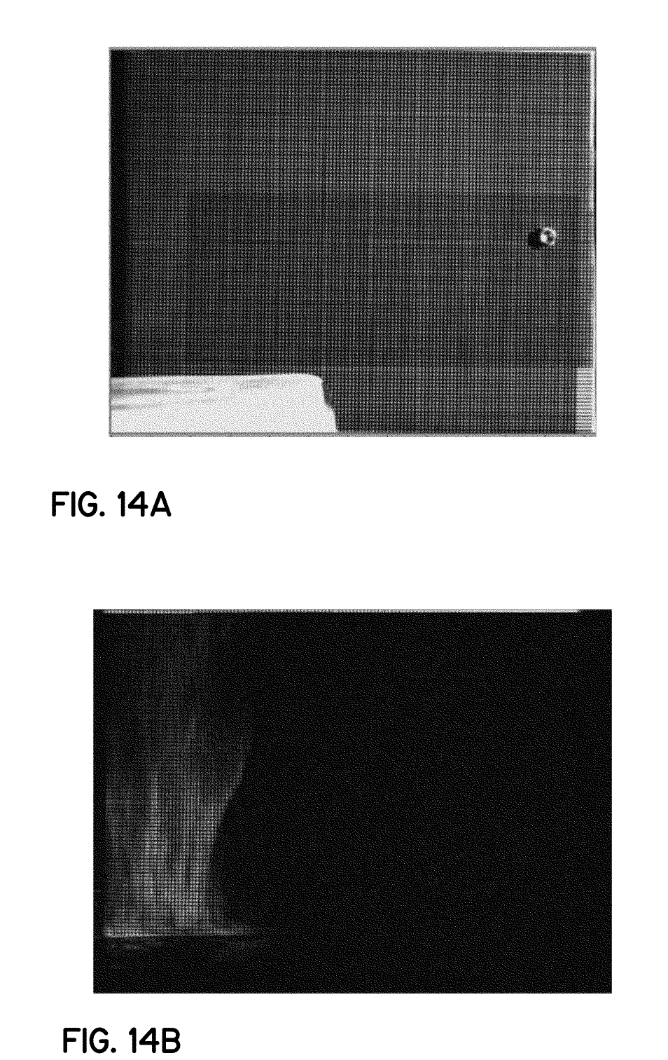

When a surface is heated the surrounding air is warmed. That air then begins to have convection currents that in turn form a turbulent field surrounding that surface. It is possible to measure the turbulence caused by the heated surface with an embodiment of the disclosed detection system. The turbulence can then be correlated to the surface that is driving the convection. The warmer the surface, the more energetic the turbulence will be. In that way, the relative intensities of the turbulence can be correlated to relative surface temperatures. FIG. 14A shows a hotplate that is turned on. The hotplate is the white surface in the lower left of the image. The image is a random frame from the time series taken by the multi-element high speed camera. FIG. 14B is a processed image depicting the turbulence. The image on the right represents one second worth of data. The turbulence over the hotplate cannot be seen with the eye and cannot be seen on playback of the regular video sequence, but it clearly visible when the image is transformed and processed in accordance with an embodiment of the present invention.

Other modifications will be apparent to one of ordinary skill in the art, as will other potential applications of the techniques described herein. Therefore, the invention lies in the claims hereinafter appended.

What is claimed is:

1. A method for detecting turbulence in a fluid, comprising:
measuring an intensity of radiation in the fluid over time;
performing a transformation of the measured intensity over time to generate an intensity of radiation over frequency; and
detecting turbulence in the fluid based upon the transformed intensity of radiation over frequency.

2. The method of claim 1, wherein detecting turbulence in the fluid comprises evaluating the transformed intensity of radiation over a pre-selected frequency or integrated range of frequencies.

3. The method of claim 2, wherein the pre-selected frequency or integrated range of frequencies is less than about 1000 Hz.

4. The method of claim 3, wherein the pre-selected frequency or integrated range of frequencies is less than about 100 Hz.

5. The method of claim 2,
wherein the fluid comprises air;
wherein the intensity of radiation is measured at an average rate of at least 20 times per second;
and wherein detecting turbulence comprises comparing the average intensity of radiation in a frequency range to a reference intensity, the higher end of the frequency range being no greater than half the average rate at which the intensity of radiation is measured.

6. The method of claim 1:
wherein measuring an intensity of radiation in a fluid over time comprises measuring a plurality of intensities of radiation over time across a field of view using a multi-element sensor array, and
wherein performing a transformation of the measured intensity over time comprises performing a transformation of the plurality of measured intensities over time to generate a plurality of intensities of radiation over frequency; and
wherein detecting turbulence in the fluid is based upon the transformed plurality of intensities of radiation over frequency.

7. The method of claim 1:
wherein the method further comprises measuring a second plurality of intensities of ambient radiation over time across a second field of view using a second multi-element sensor array that is at a different physical location from the first multi-element sensor array,
wherein the second field of view at least partially overlaps the first field of view,
wherein the method further comprises performing a transformation of the plurality of measured intensities over time to generate a second plurality of intensities of radiation over frequency, and
wherein detecting turbulence in the fluid further comprises cross-correlating the first plurality of transformed intensities and the second plurality of transformed intensities to detect the presence and location of turbulence.

8. The method of claim 7, wherein detecting turbulence in the fluid comprises detecting atmospheric turbulence potentially detrimental to air navigation.

9. The method of claim 8, wherein measuring the first and second plurality of intensities occurs on an aircraft while the aircraft is in flight.

10. The method of claim 1, wherein measuring the intensity of radiation comprises measuring the intensity of radiation proximate a container to detect turbulence arising from a leak in the container.

11. The method of claim 1, wherein measuring the intensity of radiation comprises measuring the intensity of radiation proximate exhaust gas to detect turbulence arising from the expulsion of the gas.

12. The method of claim 1, wherein measuring the intensity of radiation comprises measuring radiation proximate convection currents to detect turbulence arising from a temperature differential between the surface of a solid or liquid and a proximate fluid.

13. The method of claim 1, wherein measuring the intensity of radiation comprises measuring the radiation within a field of view that includes an obstructing element that selectively obstructs part of the field of view, the obstructing element providing selective masking that enhances detection of turbulence within the field of view.

14. The method of claim 1, wherein measuring the intensity of radiation comprises measuring an intensity of ambient radiation using a passive image detector.

15. The method of claim 1, wherein the detection of turbulence is an active detection method that further comprises emitting radiation into the fluid such that the measured intensity of radiation over time is at least in part a measurement of the emitted radiation.

16. The method of claim 15, wherein the detection method uses radar.

17. The method of claim 1, wherein the radiation consists primarily of electromagnetic radiation in the wavelength range of visible and near-infrared light.

18. A system for passively detecting turbulence in a fluid, comprising:
a passive image detector configured to measure a plurality intensities of ambient radiation over time across a field of view using a multi-element sensor array; and
a data processor configured to
receive and process the plurality of intensities of ambient radiation over time from the detector, and
detect turbulence using the processed data.

19. The system of claim 18, wherein the system further comprises an obstructing element that selectively obstructs part of the field of view of the passive image detector, the obstructing element providing selective masking that enhances detection of turbulence within the field of view.

20. The system of claim 18:
wherein the system further comprises a second image detector configured to measure a plurality of intensities of ambient radiation over time across a second field of view using a second multi-element sensor array,
wherein the second image detector is at a different physical location than the first image detector,
wherein the second field of view at least partially overlaps the first detector's field of view,
wherein the data processor is further configured to receive and process the plurality of intensities of ambient radiation over time from the second detector, and
wherein the data processor is further configured to cross-correlate the processed data from the first detector and the processed data from the second detector to detect the presence and location of turbulence.

21. The system of claim 20, wherein the system is configured to detect atmospheric turbulence potentially detrimental to air navigation.

22. The system of claim 21, wherein the first and second passive image detectors both located on an aircraft, and wherein the first and second detectors are configured to operate while the aircraft is in flight.

23. The system of claim 18, wherein the data processor is further configured to perform a transformation of the received plurality of measured intensities of radiation over time to generate a plurality of intensities of ambient radiation over frequency, and to detect turbulence in the fluid based upon the transformed intensities of radiation over frequency.

24. The system of claim 23 wherein the data processor is further configured to evaluate the transformed intensities of radiation over a pre-selected frequency or integrated range of frequencies to detect turbulence.

25. The system of claim 24, wherein the pre-selected frequency or integrated range of frequencies is less than about 1000 Hz.

26. The system of claim 24, wherein the pre-selected frequency or integrated range of frequencies is less than about 100 Hz.

27. The system of claim 24,
wherein the fluid comprises air;
wherein the plurality of intensities of ambient radiation are measured at an average rate of at least 20 times per second;
and wherein the data processor is configured to compare the average intensity of radiation in a frequency range to a reference intensity to detect turbulence, the higher end of the frequency range being no greater than half the average rate at which the intensity of radiation is measured.

28. The system of claim 18, wherein the detector is configured to measure the intensity of radiation proximate a container, and wherein the data processor is configured to detect turbulence arising from a leak in the container.

29. The system of claim 18, wherein the detector is configured to measure the intensity of radiation proximate exhaust gas, and wherein the data processor is configured to detect turbulence arising from the expulsion of the gas.

30. The system of claim 18, wherein the detector is configured to measure radiation proximate convection currents, and wherein the data processor is configured to detect turbulence arising from a temperature differential between the surface of a solid or liquid and a proximate fluid.

31. A program product, comprising:
a computer readable storage medium; and
program code stored on the computer readable storage medium and configured upon execution to receive a measured intensity of radiation over time, the intensity representing an ambient intensity of radiation transmitted through a fluid, perform a frequency transformation over a frequency range of the measured intensity to generate an integrated intensity of ambient radiation within the frequency range, and identify turbulence in the fluid based upon the integrated intensity of radiation.

32. A method for detecting turbulence in a fluid, comprising:
measuring an intensity of radiation over time;
filtering the radiation according to frequency to produce an intensity that represents only radiation with intensity fluctuations in a pre-selected frequency range; and
detecting turbulence in the fluid by evaluating the filtered intensity.

33. The method of claim 32, wherein the measured and filtered intensities are both analog signals, and wherein detecting turbulence does not involve converting the analog signals to digital signals.
